(19) United States
(12) Patent Application Publication
(10) Pub. No.: US 2024/0248661 A1
(43) Pub. Date: Jul. 25, 2024

(54) IMAGE FORMING DEVICE AND CONTROL METHOD FOR IMAGE FORMING DEVICE

(71) Applicant: Sharp Kabushiki Kaisha, Osaka (JP)

(72) Inventor: Kenji OGASAWARA, Osaka (JP)

(21) Appl. No.: 18/411,427

(22) Filed: Jan. 12, 2024

(30) Foreign Application Priority Data
Jan. 23, 2023 (JP) 2023-008280

(51) Int. Cl. G06F 3/12

(52) U.S. Cl. CPC G06F 3/1256; G06F 3/1238; G06F 3/1274; G06F 3/1287

(57) ABSTRACT

An image forming device includes a display that displays a first setting screen and a second setting screen, and one or more controllers. The first setting screen receives a setting related to an internal function of the image forming device and the second setting screen receives a setting related to cooperation with an external service. In a case of receiving an instruction to cooperate with the external service via the first setting screen, the one or more controllers switch a control mode of the device from a first control mode related to the internal function of the image forming device to a second control mode related to the cooperation with the external service, and cause a display screen to transition from the first setting screen to the second setting screen.

### TECHNICAL FIELD

The present disclosure relates to an image forming device and the like.

### BACKGROUND ART

An image forming device is known that can access an external service (authentication service) on the Internet, and that can acquire an access token from the external service.

The image forming device can use a resource managed by an authorizing entity by using the acquired access token.

### SUMMARY

### Technical Problem

In the related art, consideration has not been given to a user interface used by an image forming device for accessing an external service, and thus, the image forming device has not necessarily offered an excellent usability for a user with respect to authentication processing.

An object of the present disclosure is to provide an image forming device and the like that can improve usability for a user with respect to authentication processing, by providing a user interface for accessing an external service.

### Solution to Problem

In order to solve the problem described above, an image forming device according to the present disclosure includes a display displaying a first setting screen and a second setting screen, the first setting screen receiving a setting related to an internal function of the image forming device and the second setting screen receiving a setting related to cooperation with an external service, and one or more controllers. In a case of receiving an instruction to cooperate with the external service via the first setting screen, the one or more controllers switch a control mode of the device from a first control mode related to the internal function of the image forming device to a second control mode related to the cooperation with the external service, and cause a display screen to transition from the first setting screen to the second setting screen.

Further, a control method for an image forming device according to the present disclosure is a control method for an image forming device including a display displaying a first setting screen and a second setting screen, the first setting screen receiving a setting related to an internal function of the image forming device and the second setting screen receiving a setting related to cooperation with an external service. The control method includes, in a case of receiving an instruction to cooperate with the external service via the first setting screen, switching a control mode of the device from a first control mode related to the internal function of the image forming device to a second control mode related to the cooperation with the external service, and causing a display screen to transition from the first setting screen to the second setting screen.

### Advantageous Effects of Invention

According to the present disclosure, it is possible to provide an image forming device and the like that can improve usability for a user with respect to authentication processing, by providing a user interface for accessing an external service.

### BRIEF DESCRIPTION OF DRAWINGS

FIG. 1 is a schematic diagram for explaining an example of a connection mode of a multifunction peripheral according to a first embodiment.

FIG. 2 is a diagram for explaining a functional configuration of the multifunction peripheral according to the first embodiment.

FIG. 3 is a table for explaining different points in display control between a device internal mode and an Internet connection mode.

FIG. 4 is a sequence diagram for explaining a processing flow according to the first embodiment.

FIG. 5 is a flowchart for explaining detailed processing according to the first embodiment.

FIG. 6 is a flowchart for explaining detailed processing according to the first embodiment.

FIG. 7 is a diagram for explaining an operation example according to the first embodiment.

FIG. 8 is a diagram for explaining an operation example according to the first embodiment.

FIG. 9 is a diagram for explaining an operation example according to the first embodiment.

FIG. 10 is a diagram for explaining an operation example according to the first embodiment.

FIG. 11 is a diagram for explaining an operation example according to the first embodiment.

FIG. 12 is a diagram for explaining an operation example according to the first embodiment.

FIG. 13 is a diagram for explaining an operation example according to the first embodiment.

FIG. 14 is a diagram for explaining an operation example according to the first embodiment.

FIG. 15 is a diagram for explaining an operation example according to the first embodiment.

FIG. 16 is a diagram for explaining an operation example according to the first embodiment.

FIG. 17 is a diagram for explaining an operation example according to the first embodiment.

FIG. 18 is a diagram for explaining an operation example according to the first embodiment.

FIG. 19 is a diagram for explaining an operation example according to the first embodiment.

FIG. 20 is a diagram for explaining an operation example according to the first embodiment.

FIG. 21 is a diagram for explaining an operation example according to the first embodiment.

FIG. 22 is a diagram for explaining an operation example according to the first embodiment.

FIG. 23 is a diagram for explaining an operation example according to the first embodiment.

FIG. 24 is a diagram for explaining an operation example according to the first embodiment.

FIG. 25 is a table for explaining different points in display control between a first setting screen and a second setting screen in an integrated mode according to a second embodiment.

FIG. 26 is a flowchart for explaining detailed processing according to a third embodiment.

FIG. 27 is a diagram for explaining an operation example according to the third embodiment.

FIG. 28 is a diagram for explaining an operation example according to the third embodiment.

### DESCRIPTION OF EMBODIMENTS

Embodiments according to the present disclosure will be described below with reference to the drawings. Note that the following embodiments are examples for explaining the present disclosure, and the technical content of the explanation described in the claims is not limited to the following description.

In recent years, there has been an increase in image forming devices that realize display of an operation screen using content defined by a markup language such as a hypertext markup language (HTML). A Web browser installed in such an image forming device performs display while switching, in accordance with the purpose, between a device internal mode in which content held within the device (for example, a setting screen related to execution of a native function such as a copy function, system setting, or the like) is displayed, and an Internet connection mode in which access processing to an external service on the Internet (for example, a cloud server such as an authentication server, and the like) is performed.

In the device internal mode, a screen transition from a displayed setting screen or the like to an authentication screen or the like provided by an external service is not assumed. Thus, in order to switch a control mode from the device internal mode to the Internet connection mode, at first, it is necessary to initialize internal settings of the Web browser via an “about: blank” state.

As one mode of the access processing with respect to the external service, an information processing device is known that acquires an access token by using an authorization code received from the external service based on OAuth authentication. However, a user interface for accessing the external service is not provided. Thus, a seamless transition from the device internal mode to the Internet connection mode has not been considered.

In each of the following embodiments of the present disclosure, an image forming device is realized that can improve usability for a user with respect to authentication processing by, upon receiving an instruction to cooperate with an external service, switch a control mode of the device from a first control mode related to internal functions of the image forming device to a second control mode related to cooperation with the external service, and cause a display screen to transition from a first setting screen to a second setting screen.

### 1. FIRST EMBODIMENT

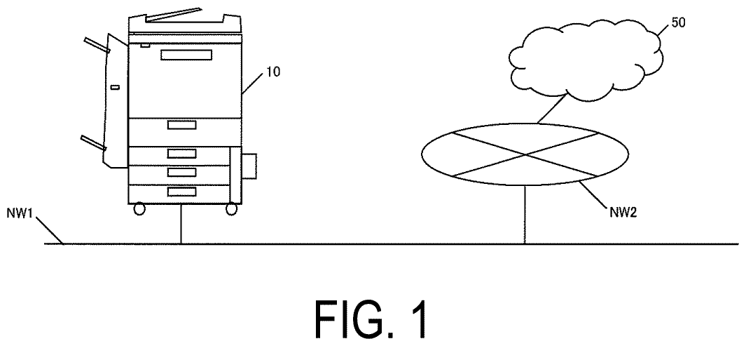

FIG. 1 is a diagram for explaining an example of a connection mode between a multifunction peripheral 10 as an image forming device according to the present disclosure, and an external service 50. The multifunction peripheral 10 is connected to the external service 50 via a network NW1 and a network NW2. The network NW1 and the network NW2 represent network lines such as a local area network (LAN), a wide area network (WAN), and the Internet. Note that the external service 50 maybe connected to the network NW1, and the connection mode thereof is not limited.

The multifunction peripheral 10 according to a first embodiment is an image forming device that can execute each of jobs such as print, copy, fax, and image transmission in one housing.

The multifunction peripheral 10 is configured to communicate with the external service 50 using a communication protocol such as a hypertext transfer protocol (HTTP).

For example, the external service 50 can be configured as a cloud server that performs authorization of a resource provided by the external service 50 or the like, by performing an authorization code flow based on OAuth 2.0 authentication. The configuration of the external service 50 is not limited as long as the external service 50 is configured to generate an authorization code and an access token in accordance with the success or failure of the authorization. For example, a device for processing the authorization code flow and a device for providing the resource may be configured separately.

### 1.1 Functional Configuration

### 1.1.1 Multifunction Peripheral 10

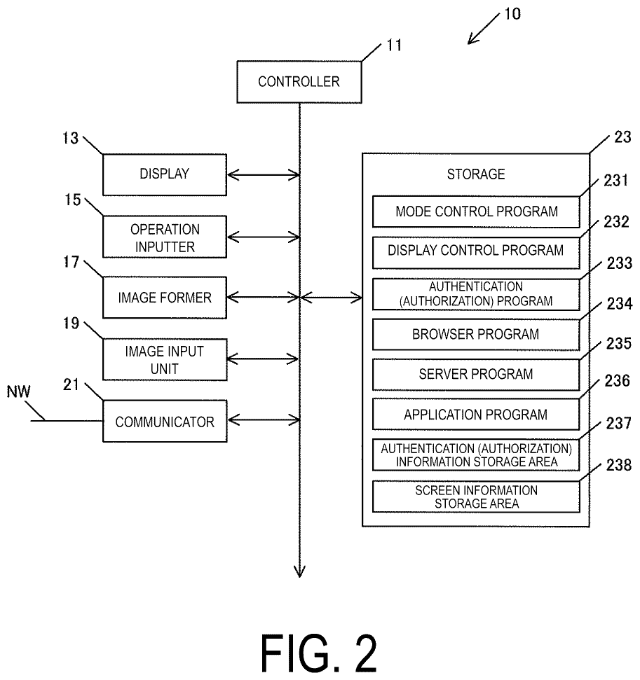

A functional configuration of the multifunction peripheral 10 according to the first embodiment will be described. FIG. 2 is a functional configuration diagram of the multifunction peripheral 10. The multifunction peripheral 10 includes a controller 11, a display 13, an operation inputter 15, an image former 17, an image inputter 19, a communicator 21, and a storage 23.

The controller 11 controls the entire multifunction peripheral 10. The controller 11 is configured of, for example, one or multiple arithmetic devices (central processing units (CPUs) or the like). The controller 11 realizes the function thereof by reading and executing various programs stored in the storage 23.

The display 13 is a display device that displays various types of information for a user or the like. The display 13 can be constituted by, for example, a liquid crystal display (LCD), an organic electro-luminescence (EL) display, or the like. The display 13 can display, based on control by the controller 11, setting screens (operation screens) based on browsing screen information generated by (reading) a browser program 234, which will be described later.

The operation inputter 15 receives an input of information by the user or the like. The operation inputter 15 can be constituted by, for example, various input devices such as operation keys (for example, hardware keys and software keys) and buttons. The operation inputter 15 can be configured as a touch panel that enables input via the display 13. In this case, as an input method for the touch panel, for example, a general method such as a resistance film method, an infrared beam method, an electromagnetic induction method, or an electrostatic capacitance method can be employed.

The image former 17 forms an image on paper or the like, which serves as a recording medium, based on image data. The image former 17 feeds the paper from a feed tray (not illustrated), forms an image on the paper based on the image data, and then discharges the paper to a paper discharger (not illustrated). The image former 17 can be constituted by, for example, a laser printer using an electrophotographic system. In this case, the image former 17 performs image formation using toners supplied from toner cartridges (not illustrated) corresponding to toner colors (for example, cyan, magenta, yellow, and black), respectively.

The image inputter 19 generates image data by scanning a document. The image inputter 19 can be configured as a scanner device that is provided with, for example, an image sensor such as a charge coupled device (CCD) or a contact image sensor (CID), and that includes an automatic document feeder (ADF), a flatbed on which a document is placed to be read, and the like. The configuration of the image inputter 19 is not particularly limited as long as the image inputter 19 can generate the image data by reading a reflected light image from an original image using the image sensor. Note that the image inputter 19 maybe configured as an interface that can acquire, for example, image data stored in a portable storage medium such as a universal serial bus (USB) memory, image data transmitted from an external terminal device (not illustrated), and the like.

The communicator 21 includes, for example, either or both of wired and wireless interfaces for performing communication with other devices (for example, the external service 50, or an external terminal device (not illustrated)) via a network (NW) such as LAN, WAN, the Internet, a telephone line, or a fax line. In addition, the communicator 21 may include an interface related to (short-range) wireless communication technology such as Bluetooth (trade name), near-field communication (NFC), Wi-Fi (trade name), ZigBee (trade name), Irda, or a wireless USB.

The storage 23 stores various programs and various types of data necessary for the operation of the multifunction peripheral 10. The storage 23 maybe constituted by, for example, a storage device such as a random access memory (RAM), a hard disk drive (HDD), a solid state drive (SSD), or a read only memory (ROM).

In the first embodiment, the storage 23 stores a mode control program 231, a display control program 232, an authentication (authorization) program 233, and the browser program 234, a server program 235, and an application program 236, and secures an authentication (authorization) information storage area 237 and a screen information storage area 238.

The mode control program 231 is a program read by the controller 11 when the controller 11 controls a setting screen displayed on the display 13 of the multifunction peripheral 10, in a specific mode. In the present disclosure, a control mode for controlling display of a first setting screen for realizing an internal function (also referred to as a native function) of an image forming device included in the multifunction peripheral 10 is defined as a first control mode (hereinafter referred to as a device internal mode). The setting screens controlled in the device internal mode may include operation screens related to operations for maintaining a device state of the multifunction peripheral 10 (for example, inputs and selections of device settings via a system setting screen, maintenance and management of the device state such as replenishment of consumables such as toners and paper, and the like), in addition to operation screens related to setting, execution, post-processing, and the like of jobs such as printing, copying, faxing, image transmission, and the like, which are the internal functions of the image forming device. On the other hand, as a different control mode from the device internal mode, a control mode for controlling a second setting screen, with which the multifunction peripheral 10 realizes cooperation with the external service 50, is defined as a second control mode (hereinafter referred to as an Internet connection mode). The setting screens controlled by the Internet connection mode include screens related to the cooperation with the external service 50, presentation of an authorization code or an access token issued by the external service 50, issuance of a request for a resource to the external service 50, and the like.

The controller 11 that has read the mode control program 231 controls the multifunction peripheral 10 in the device internal mode or the Internet connection mode, and also switches the control mode between the device internal mode and the Internet connection mode, based on a control mode switching determination performed in an internal server, which will be described later. Note that the mode control program 231 may be implemented as one function of the server program 235, which will be described below.

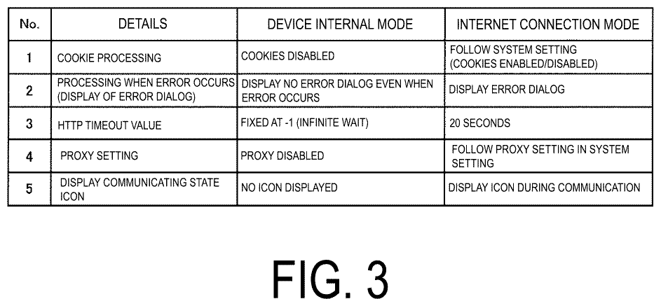

Here, different points in display control between the device internal mode and the Internet connection mode will be described with reference to the table illustrated in FIG. 3. In FIG. 3, as the different points, cookie processing, processing at a time when an error occurs (display of an error dialog), HTTP timeout value, proxy setting, and display of a communicating state icon will be described.

In the device internal mode, communication with other external terminal devices including the external service 50 is not performed via the network NW1 (network NW2). Therefore, main operation (setting) examples are cookie processing: “cookies disabled”, processing at a time when an error occurs (display of an error dialog): “no error dialog is displayed even when an error occurs”, HTTP timeout value: “fixed at −1 (infinite wait)”, proxy setting: “proxy disabled”, and display of a communicating state icon: “icon is not displayed”.

On the other hand, in the Internet connection mode, communication with other external terminal devices including the external service 50 is performed via the network NW1 (network NW2). Therefore, main operation (setting) examples are cookie processing: “follow system setting (cookies enabled/disabled)”, processing at a time when an error occurs (display of an error dialog): “display an error dialog”, HTTP timeout value: “20 seconds”, proxy setting: “follow proxy setting in system setting”, and display of a communicating state icon: “icon is displayed during communication”.

Returning to FIG. 2 once again, the display control program 232 is a program read by the controller 11 when the controller 11 controls the display 13.

The authentication (authorization) program 233 is a program read by the controller 11 when the controller 11 performs the authentication (authorization) processing with the external service 50. The controller 11 that has read the authentication (authorization) program 233 performs, via the Web browser, the cooperation with the external service 50, the presentation of the authorization code or the access token issued from the external service 50, or the issuance of the request for the resource to the external service 50. Note that, in addition to an authentication method that requires a prior authorization such as the OAuth 2.0 authentication, the controller 11 that has read the authentication (authorization) program 233 can perform, for example, known authentication (processing) in which authentication is performed using a combination of a username (user ID) and a password, login authentication with respect to the multifunction peripheral 10, or administrator authentication for authenticating a user having administrator privileges (administrator user).

The browser program 234 is a program read by the controller 11 when the controller 11 generates browsing image information by rendering input content. The controller 11 that has read the browser program 234 functions as a Web browser, and communicates with the internal server or the external service 50 to request the internal server or the external service 50 to acquire content corresponding to the setting screen or the like, for example.

The server program 235 is a program read by the controller 11 when the controller 11 outputs, to a Web browser, a response corresponding to a request from the Web browser. The controller 11 that has read the server program 235 functions as the internal server (localhost), and outputs, to the Web browser, content corresponding to a setting screen related to the device internal mode. In addition, the controller 11 that has read the server program 235 performs a determination as to whether to switch between the device internal mode and the Internet connection mode, in accordance with the instruction to cooperate with the external service 50.

The application program 236 is an application that functions using a resource provided by the external service 50. The application program 236 may be an integrated management application that controls settings, management, and the like of the multifunction peripheral 10, or may be an individual application (for example, an image transmission application or the like) using the integrated management application as a platform.

The authentication (authorization) information storage area 237 is a storage area for storing authentication (authorization) information related to the authentication (authorization) processing. The authentication (authorization) information storage area 237 stores the authentication (authorization) information such as a name (provider name) of the external service 50 associated with the authentication method, and an account name with respect to the external service 50.

The screen information storage area 238 is a storage area for storing content output by the internal server to the Web browser. The screen information storage area 238 stores at least content related to the setting screen of the device internal mode.

### 1.1.2 External Service 50

The external service 50 employs the OAuth 2.0 authentication as the authentication method, and a known configuration can be used as long as the configuration can provide services such as mail delivery and data sharing (storage). Therefore, the functional configuration of the external service 50 is not described herein.

### 1.2 Processing Flow

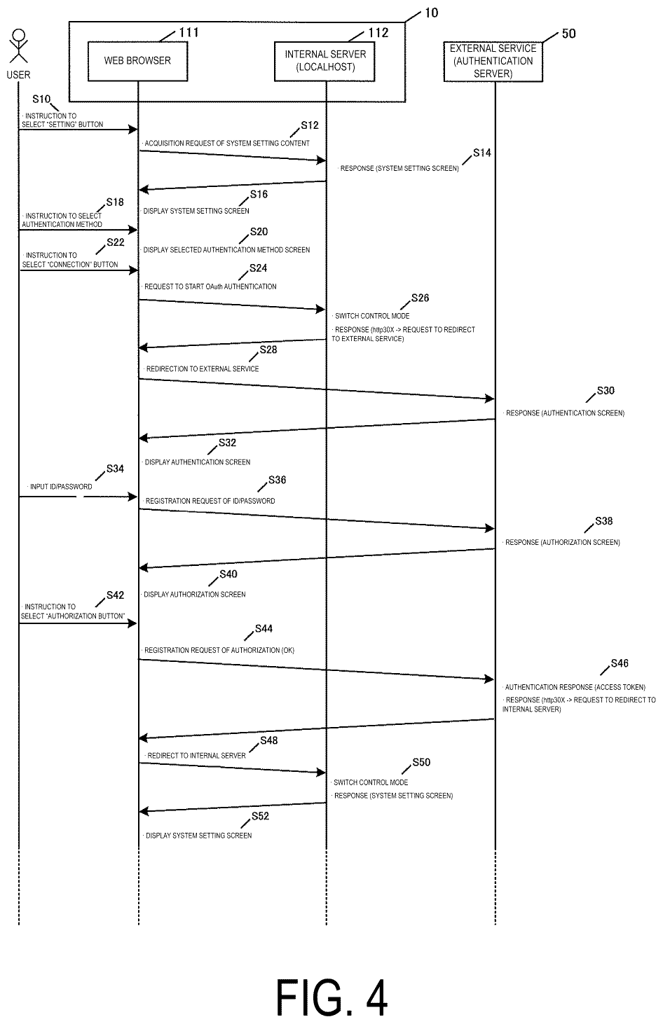

Next, an overall processing flow according to the first embodiment will be described with reference to the sequence diagram illustrated in FIG. 4. In the processing illustrated in FIG. 4, it is assumed that the multifunction peripheral 10 is operating in the device internal mode. Note that a functional configuration realized by the controller 11 reading the browser program 234 will be referred to as a Web browser 111, and a functional configuration realized by the controller 11 reading the server program 235 will be referred to as an internal server 112.

The user selects a “setting” button, which is an instruction to display a system setting screen, via a home screen or the like of the multifunction peripheral 10 displayed via the Web browser 111. The Web browser 111 receives the selection instruction (step S10).

Upon receiving the instruction to select the “setting” button, the Web browser 111 outputs, to the internal server 112, an acquisition request (GET) for content (system setting content) corresponding to the system setting screen (step S12). Upon receiving the input of the acquisition request from the Web browser 111, the internal server 112 outputs, to the Web browser 111, the system setting content as a response to the acquisition request (step S14).

The Web browser 111 displays, on the display 13, the system setting screen based on the system setting content (step S16).

Subsequently, the Web browser 111 receives the selection of the authentication method from the user via the system setting screen (step S18). Upon receiving the selection instruction from the user, the Web browser 111 displays an authentication method screen for receiving an input of authentication information and the like related to the selected authentication method (step S20).

The user inputs necessary authentication information to the authentication method screen displayed via the Web browser 111, and selects a “connection” button, which is an instruction to start the OAuth authentication. The Web browser 111 receives the selection instruction (step S22).

Upon receiving the instruction to select the “connection” button, the Web browser 111 outputs a request to start the OAuth authentication to the internal server 112 (step S24).

Upon receiving the input of the request to start the OAuth authentication, the internal server 112 determines to switch the control mode from the device internal mode to the Internet connection mode. Subsequently, the internal server 112 (controller 11) reads the mode control program 231, and switches the control mode from the device internal mode to the Internet connection mode. Then, as a response, the internal server 112 outputs an HTTP status code 30X (redirection to the external service 50) to the Web browser 111 (step S26).

The Web browser 111 that has received the input of the HTTP status code 30X performs redirection to the external service 50 (step S28).

As a response, the external service 50 outputs content corresponding to an authentication screen (authentication screen content) to the Web browser 111 (step S30).

The Web browser 111 displays, on the display 13, the authentication screen based on the authentication screen content (step S32).

The user inputs an ID and a password as authentication information with respect to the external service 50 via the authentication screen (step S34). Upon receiving the input of the ID and the password from the user, the Web browser 111 outputs, to the external service 50, a registration (POST) request for registering the ID and the password (step S36).

When the authentication based on the combination of the input ID and password of the user is successful, as a response, the external service 50 outputs, to the Web browser 111, content corresponding to an authorization screen (authorization screen content) for using a resource (step S38).

The Web browser 111 displays, on the display 13, the authorization screen based on the authorization screen content (step S40).

The user decides whether or not to allow use of the resource via the authorization screen. Specifically, the user allows the use of the resource by selecting an “authorize” button on the authorization screen.

Upon receiving the “authorize” button selection instruction (step S42), the Web browser 111 outputs, to the external service 50, a registration request for registering authorization (OK) (step S44).

Upon receiving the registration request of the authorization, the external service 50 outputs an access token to the Web browser 111, as an authorization response. In addition, as a response, the external service 50 outputs, to the Web browser 111, the HTTP status code 30X (redirection to the internal server 112) (step S46).

The Web browser 111 that has received the input of the HTTP status code 30X performs redirection to the internal server 112 (step S48).

Upon receiving the redirection from the Web browser 111, the internal server 112 determines to switch the control mode from the Internet connection mode to the device internal mode. Subsequently, the controller 11 reads the mode control program 231, and switches the control mode from the Internet connection mode to the device internal mode. Then, as a response, the internal server 112 outputs the system setting content to the Web browser 111 (step S50).

The Web browser 111 displays, on the display 13, the system setting screen based on the system setting content (step S52).

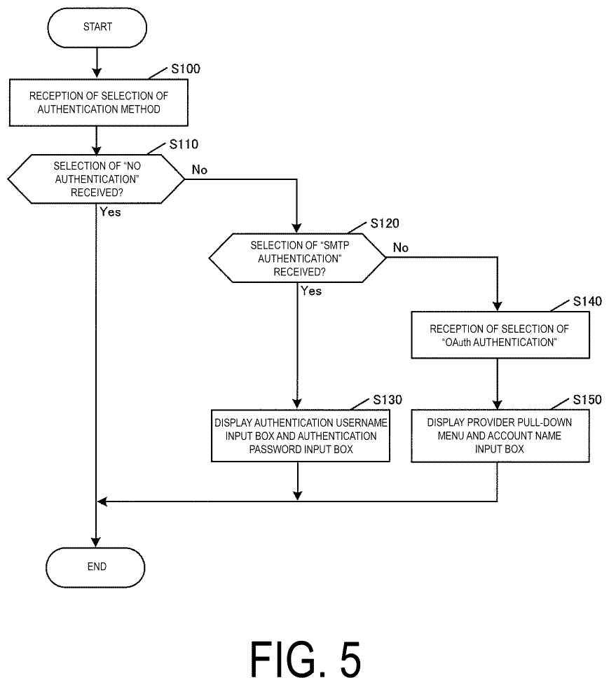

Next, detailed processing from step S18 to step S20 in FIG. 4 will be described with reference to the flowchart illustrated in FIG. 5. The processing described here is processing for displaying an advanced setting screen (region) based on the authentication method selected by the user, and will be described as processing executed by the controller 11 that has read the browser program 234 and the server program 235.

The controller 11 receives the selection of the authentication method by the user, via the displayed system setting screen (step S100). Subsequently, the controller 11 determines whether or not the received authentication method is “no authentication” (step S110). When the received authentication method is “no authentication”, the controller 11 ends the processing (Yes at step S110 → End).

On the other hand, when the received authentication method is not “no authentication”, the controller 11 determines whether or not the received authentication method is “SMTP authentication” (No at step S110 → step S120). When the received authentication method is “SMTP authentication”, the controller 11 displays, on the system setting screen, an authentication username input box and an authentication password input box, both of which will be described later, and ends the processing (Yes at step S120 → step S130).

On the other hand, when the received authentication method is not “SMTP authentication”, the controller 11 determines that “OAuth authentication” has been received (No at step S120 → step S140). Then, the controller 11 displays, on the system setting screen, a provider pull-down menu and an account name input box, both of which will be described later, and ends the processing (step S150).

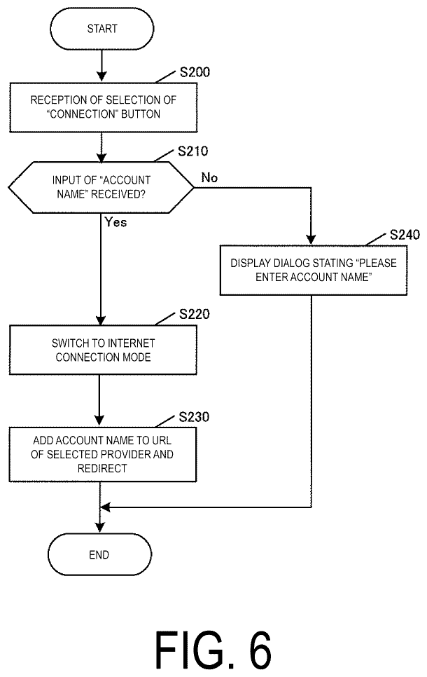

Next, detailed processing from step S22 to step S26 in FIG. 4 will be described with reference to the flowchart illustrated in FIG. 6. The processing described here relates to processing for switching the control mode when the authentication method selected by the user is “OAuth authentication”, and will be described as processing executed by the controller 11 that has read the browser program 234 and the server program 235.

The controller 11 receives, via the system setting screen, an instruction to select the “connection” button as a cooperation instruction from the user (step S200). Subsequently, the controller 11 determines whether or not an input of an “account name” with respect to the external service 50 has been received (step S210). When it is determined that the input of the “account name” has been received, the controller 11 switches the control mode to the Internet connection mode (Yes at step S210 → step S220). Then, the controller 11 adds the input “account name” to a URL of the selected provider, redirects the URL, and ends the processing (step S230).

On the other hand, when it is determined that the input of the “account name” has not been received, the controller 11 displays a dialog stating “Please enter an account name” as content, and ends the processing (No at step S210 → step S240).

### 1.3 Operation Examples

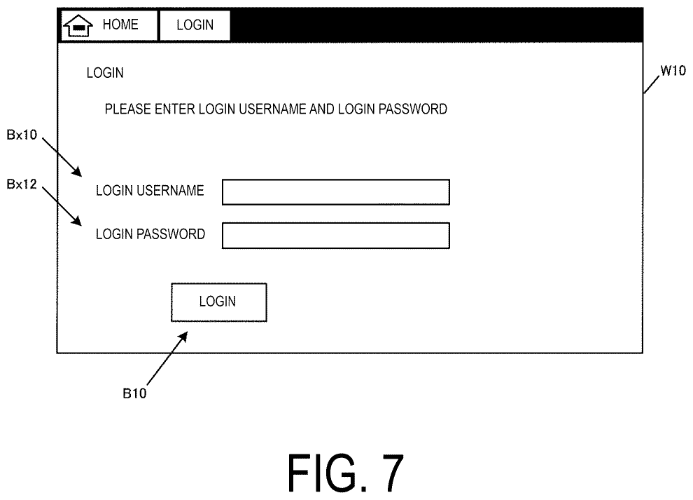

Next, operation examples according to the first embodiment will be described. FIG. 7 is a diagram for explaining a configuration example of a login screen W10 that is displayed on the display 13 by the controller 11 when a user authentication function is enabled.

The login screen W10 includes a login username input box Bx10, a login password input box Bx12, and a login button B10.

The login username input box Bx10 receives an input of a login username of the user who attempts to log in to the multifunction peripheral 10. Note that the login username may be directly input by using an input device such as a keyboard, or may be input by selecting a username from a list of usernames, which is displayed by the user pressing a selection button from a list provided separately.

The login password input box Bx12 is an input box for receiving an input of a login password corresponding to the login username. The user who attempts to log in to the multifunction peripheral 10 inputs the login password together with the login username.

The login button B10 is a button for receiving an instruction to confirm the input operation by the user. After completing the input to the login username input box Bx10 or the login password input box Bx12, the user selects the login button B10. Upon receiving the instruction to select the login button B10, the controller 11 performs authentication processing of the login user. Note that a user authenticating entity may be a single device, or may be, for example, a login authentication server or the like separately provided on the network (NW). When the single device is designated as the user authenticating entity, the controller 11 performs user authentication by comparing the input login username and login password with authentication information prepared in advance (for example, combinations of usernames and passwords or the like). On the other hand, when the login authentication server (not illustrated) provided on the network (NW) is designated as the user authenticating entity, the controller 11 performs the user authentication by transmitting the input login username and login password to the login authentication server and receiving an authentication result from the login authentication server.

In addition to the combination of the login username and the login password, the login user authentication processing may be performed using, for example, a combination of an identification number, a registration number or the like, and a login password or the like, or by using property authentication using a token, a key, an integrated circuit (IC) card, a smartphone, or the like, or biometric authentication such as fingerprint authentication or face authentication.

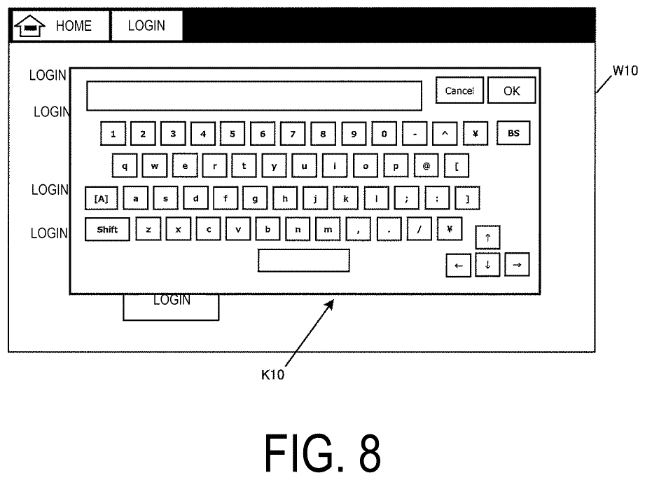

FIG. 8 is a diagram for explaining a configuration example of a software keyboard K10 displayed in response to the selection of the login username input box Bx10 or the login password input box Bx12. The user can input the login username or the login password by operating the software keyboard K10 displayed on the login screen W10.

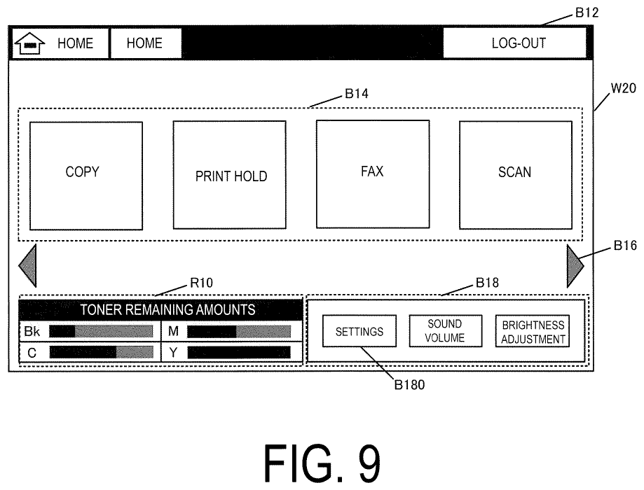

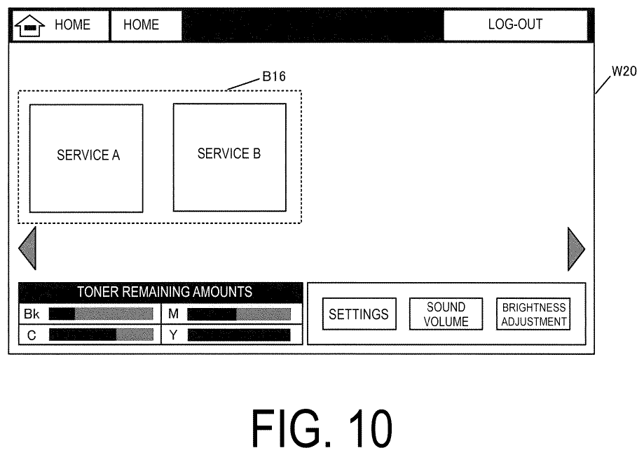

FIGS. 9 and 10 are diagrams for explaining a configuration example of a home screen W20 displayed by the controller 11 when the login authentication is successful. The home screen W20 is a basic screen for receiving an operation input from the user. The home screen W20 includes a logout button B12, a job type selection button B14, a job type switching button B16, a function selection button B18, and a device state display region R10.

The logout button B12 is a button for receiving a logout instruction of the login user. Upon receiving the instruction to select the logout button B12, the controller 11 causes a login state of the login user with respect to the multifunction peripheral 10 to end. Then, the controller 11 causes the display screen to transition to the login screen W10 exemplified in FIG. 7.

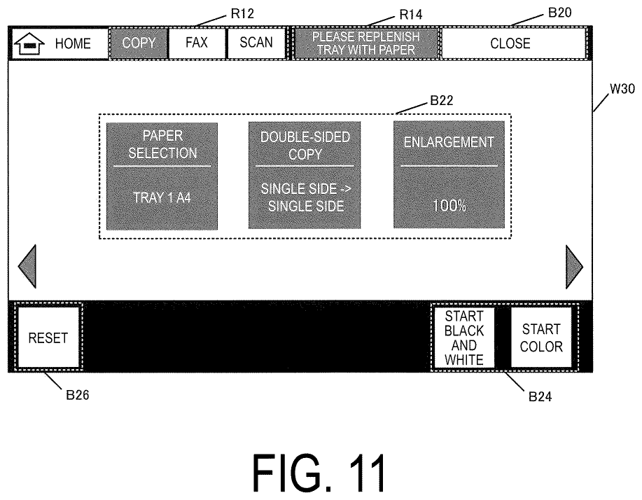

The job type selection button B14 is a button for receiving the selection of a job type of a job desired by the user. FIG. 9 illustrates an example in which selection buttons related to copy, print hold, fax, and scan are displayed as the job types that can be selected by the user. When the user selects the job type selection button B14 related to any one of the job types, the controller 11 displays a setting screen corresponding to each of the job types exemplified in FIGS. 11 to 13. Note that the job type switching button B16 is a button for receiving an instruction to switch the job type selection button B14. When the job type switching button B16 is selected, the controller 11 switches display of selection buttons displayed on the job type selection button B14. FIG. 10 is a diagram for explaining a display configuration example of other job types (connection to service A, connection to service B) displayed by the controller 11 in response to the instruction to select the job type switching button B16 by the user.

The function selection button B18 is a button for receiving a change instruction, a reference instruction, and the like related to functional setting of the multifunction peripheral 10. Upon receiving an instruction to select the function selection button B18, the controller 11 displays a setting screen for executing the change instruction, the reference instruction, or the like of the corresponding function. FIG. 9 illustrates an example in which a setting button B180, a volume button, and a brightness adjustment button are displayed as function selection buttons that can be selected by the user. Note that a system setting screen displayed by the controller 11 in response to the selection of the setting button B180 will be described later.

The device state display region R10 is a region for displaying the device state of the multifunction peripheral 10. FIG. 9 illustrates an example in which remaining amounts of the toners are displayed in the device state display region R10.

FIG. 11 is a diagram for explaining an example of a screen configuration of a copy setting screen W30 displayed by the controller 11 when the copy job is selected as the job type selection button B14 exemplified in FIG. 9. The copy setting screen W30 includes a selected job type display region R12, a notification information display region R14, a close button B20, a setting value input button B22, a start button B24, and a reset button B26.

The selected job type display region R12 functions as an indicator for notifying the user as to which job the current setting screen is related. FIG. 11 illustrates an example in which the currently displayed setting screen is a setting screen related to the copy job, and a display region related to the copy job is inversely displayed. Note that when the selectable job types are three job types such as copy, fax, and scan, these job types may be displayed as a set as exemplified in FIG. 11. Further, each of the regions indicating the job type also functions as a switching button for receiving an instruction to switch the job type. The user can switch the job type from the currently selected job type to a desired job type by selecting the switching button, without returning to the home screen W20.

The notification information display region R14 is a region for displaying a notification to the user in relation to the execution of the copy job. FIG. 11 illustrates an example in which “Please replenish the tray with paper” is displayed as the notification information. The information displayed in the notification information display region R14 includes information related to an error, a warning, and the like. When an issue that has prompted the display of the information related to the error, the warning, or the like is solved, the controller 11 ends the display of the information in the notification information display region R14 (for example, when the tray is replenished with the paper).

The close button B20 is a button for receiving an instruction to end the display of the copy setting screen W30. When the close button B20 is selected by the user, the controller 11 ends the display of the copy setting screen W30, and causes the display screen to transition to the home screen W20.

The setting value input button B22 is a button for receiving an input of a setting value that can be set by the user when executing a copy job. FIG. 11 illustrates an example in which buttons for receiving inputs of setting values for paper selection, double-sided copying, and enlargement are displayed as the setting value input buttons B22. In the setting value input button B22, the currently set setting value (for example, paper selection: tray 1, A4) is displayed. The user checks the setting value displayed on the setting value input button B22, and when there is no need to change the setting value, the user does not perform any operation, and when the setting value needs changing, the user selects the corresponding setting value input button B22, and inputs a desired setting value so that the setting value can be reflected in the execution of the copy job.

The start button B24 includes a black-and-white start button and a color start button. When the user desires to copy in black and white, the user selects the black-and-white start button. On the other hand, when the user desires to copy in color, the user selects the color start button. Upon receiving the selection of one of the black-and-white start button and the color start button, the controller 11 executes either the copy in black and white or the copy in color as the copy job.

The reset button B26 is a button for receiving an input of an instruction to reset the setting value input or changed via the setting value input button B22. When the reset button B26 is selected, the controller 11 resets the input or changed setting value to a default value, for example.

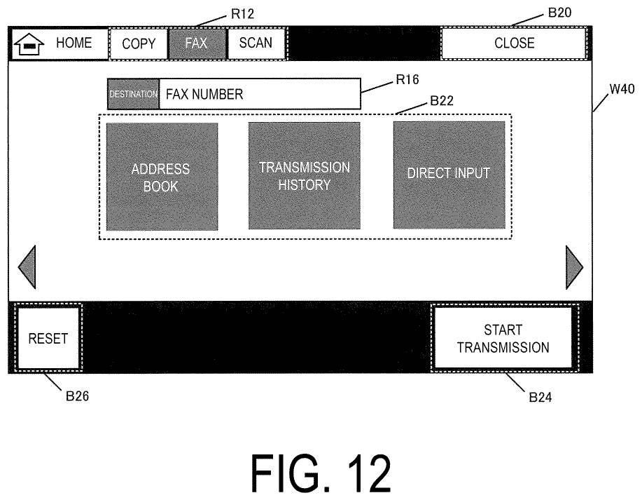

FIG. 12 is a diagram for explaining an example of a screen configuration of a fax setting screen W40 displayed by the controller 11 when a fax job is selected as the job type selection button B14 exemplified in FIG. 9. The fax setting screen W40 includes the selected job type display region R12, the close button B20, the setting value input button B22, the start button B24, the reset button B26, and a destination display region R16. Note that description of the same configuration as that of the copy setting screen W30 exemplified in FIG. 11 will be omitted, and points where the two configurations differ will be described.

The setting value input button B22 is a button for receiving an input of a setting value that can be set by the user in relation to the execution of a fax job. FIG. 12 illustrates an example in which buttons for receiving inputs of setting values for address book, transmission history, and direct input (of a fax number) are displayed as the setting value input buttons B22. FIG. 12 illustrates an example in which buttons for supporting an input of a transmission destination of the fax transmission are displayed as the setting value input buttons B22. For example, when the address book is selected by the user, the controller 11 displays an address book managed by the multifunction peripheral 10, and receives the selection of the transmission destination from the address book. When the transmission history is selected by the user, the controller 11 displays a list of fax transmission histories of the past, and receives the selection of the transmission destination from the histories. When direct input is selected by the user, the controller 11 displays the software keyboard K10 exemplified in FIG. 8, and receives a fax number directly input by the user via the software keyboard K10 as the transmission destination.

The destination display region R16 is a region for displaying the transmission destination received via the setting value input button B22, namely, the address book button, the transmission history button, or the direct input button.

The start button B24 is a button for receiving an instruction to start the fax transmission to the transmission destination displayed in the destination display region R16. When the start button B24 is selected, the controller 11 starts the fax transmission.

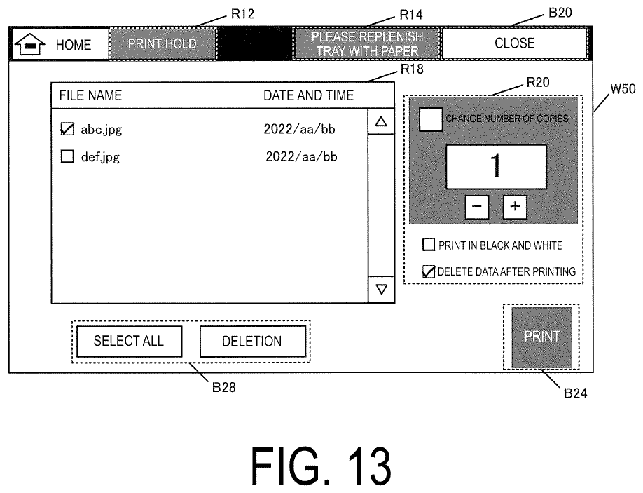

FIG. 13 is a diagram for explaining an example of a screen configuration of a print hold setting screen W50 displayed by the controller 11 when the print hold job is selected as the job type selection button B14 exemplified in FIG. 9. The print hold setting screen W50 includes a hold file display region R18, a print setting region R20, the start button B24, and a select all/delete button B28. Note that description of the same configuration as that of the copy setting screen W30 exemplified in FIG. 11 will be omitted, and points where the two configurations differ will be described.

The hold file display region R18 is a region for displaying print-held files in a selectable manner. The print hold display region R18 includes a file name and a date and time as display items. The file name indicates a file name of the print-held file. The date and time indicates a date and time when the file is set as the print-held file. Note that, in addition to the file name of a target file, a file (folder) path indicating a storage destination of the target file, information about file attributes, and the like may also be displayed in the file name. The file name is provided with a check box for receiving an instruction to select print execution of the file. The user can perform printing of the file by checking the check box and selecting the start button B24.

The print setting region R20 is a region for receiving a print setting of the file selected in the print hold file display region R18. The print setting region R20 includes setting items such as a check box for changing the number of copies, the number of copies to be printed, a check box for printing in black and white, and a check box for deleting data after printing. When the user wishes to change the number of copies (“1” in the example in FIG. 13) displayed as the number of copies to be printed, the user can change the number of copies to be printed by checking the check box for changing the number of copies and selecting and inputting a desired number of copies using a plus (+) button, a minus (−) button, or directly inputting the desired number of copies. The check box for printing in black and white is a check box for receiving an instruction to print in a color mode. Upon receiving an instruction to select the check box for printing in black and white from the user, the controller 11 performs the printing in a black and white mode. Note that when the check box for printing in black and white is not checked, the controller 11 executes the printing in the color mode. The data deletion check box is a check box for receiving an instruction to delete the target file after printing. Upon receiving an instruction to select the data deletion check box from the user after the printing, the controller 11 deletes the target file from the storage destination (for example, the storage 23) after performing the printing.

The select all/delete button B28 is a button for receiving an instruction to select all files displayed in the print hold file display region R18, or an instruction to end display of the file whose check box has been checked. For example, upon receiving an instruction to select the select all button, the controller 11 sets all the files displayed in the print hold file display region R18 as print target files. In this case, the check boxes corresponding to all the files are automatically checked. On the other hand, upon receiving an instruction to select the delete button, the controller 11 ends the display of the checked file, thereby deleting the file from the print hold file display region R18. At this time, the checked file may also be deleted from the storage destination (for example, the storage 23).

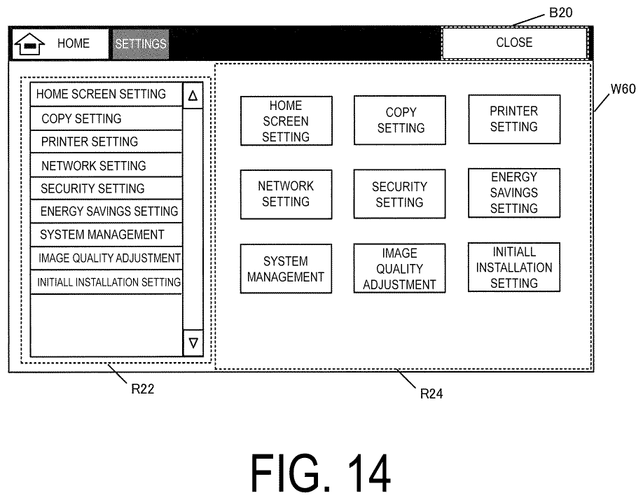

FIG. 14 is a diagram for explaining an example of a screen configuration of a system setting screen W60 as a first setting screen displayed by the controller 11 when the setting button B180 exemplified in FIG. 9 is selected. The system setting screen W60 includes a selection item display region R22, an advanced setting region R24, and the close button B20.

The selection item display region R22 is a region in which setting items that can be set by the user are displayed in a selectable manner. FIG. 14 illustrates an example in which home screen setting, copy setting, printer setting, network setting, security setting, energy saving setting, system management, image quality adjustment, and initial installation setting are displayed as items that can be selected by the user.

The advanced setting region R24 is a region for displaying setting items for receiving an input of a setting value or the like for an item selected in the selection item display region R22. Note that, in the example in FIG. 14, since an item to be set is not selected in the selection item display region R22, a list of the selection items is displayed in the advanced setting region R24.

The close button B20 is a button for receiving an instruction to end the display of the system setting screen W60. When the close button B20 is selected by the user, the controller 11 ends the display of the system setting screen W60, and causes the display screen to transition to the home screen W20.

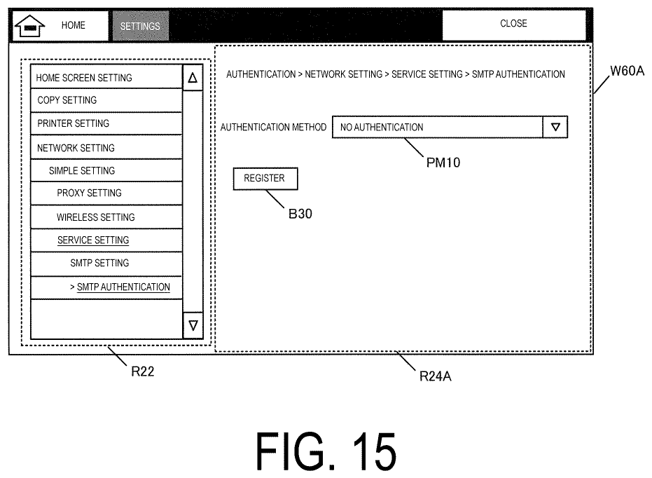

FIG. 15 is a diagram for explaining an example of a screen configuration of a system setting screen W60A when the user selects the network setting in the selection item display region R22.

In the network setting according to the present disclosure, any one of items of easy setting, proxy setting, wireless setting, and service setting can be selected. FIG. 15 illustrates an example in which SMTP authentication is selected by the user with respect to SMTP setting located under the service setting.

When the SMTP authentication is selected by the user in the selection item display region R22, the controller 11 displays setting items exemplified in an advanced setting region R24A. The advanced setting region R24A exemplified in FIG. 15 includes an authentication method pull-down menu PM10 and a registration button B30.

The authentication method pull-down menu PM10 receives the selection of the authentication method by the user. When a downward arrow provided at one end of the menu is selected by the user, the authentication method pull-down menu PM10 displays authentication methods that can be selected by the user.

The registration button B30 is a button for receiving an instruction to register the authentication method selected by the user in the authentication method pull-down menu PM10. Upon receiving an instruction to select the registration button B30 from the user, the controller 11 registers the authentication method selected in the authentication method pull-down menu PM10.

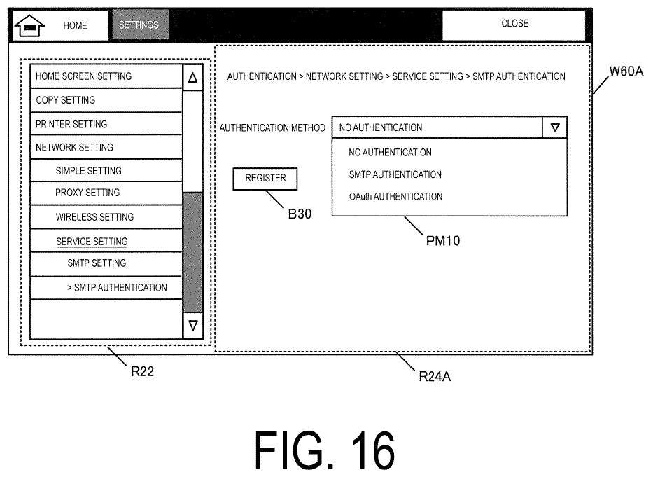

FIG. 16 is a diagram for explaining an operation example in a case where the downward arrow of the authentication method pull-down menu PM10 is selected by the user. Upon receiving the selection of the downward arrow by the user, the controller 11 displays the list of the authentication methods that can be selected by the user, by expanding the display region of the authentication method pull-down menu PM10 in the downward direction. FIG. 16 is an example in which no authentication, SMTP authentication, and OAuth authentication are displayed as the authentication methods that can be selected by the user.

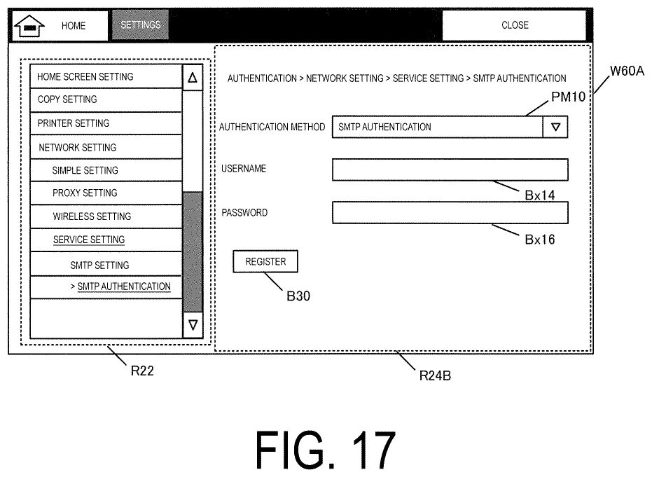

FIG. 17 is a diagram for explaining an example of a display configuration of an advanced setting region R24B displayed by the controller 11 when the user selects the SMTP authentication via the authentication method pull-down menu PM10. Upon receiving an instruction to select the SMTP authentication method as the authentication method, the controller 11 displays, in the advanced setting region R24B, an authentication username input box Bx14 for receiving an input of a username required for the SMTP authentication, and an authentication password input box Bx16 for receiving an input of an authentication password.

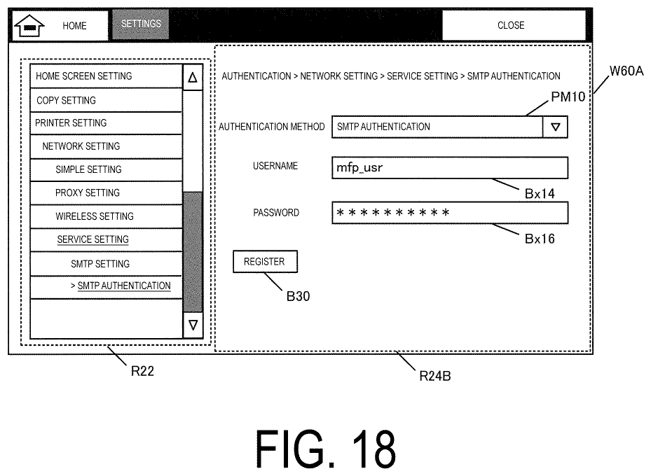

FIG. 18 illustrates an example in which the user inputs, in the advanced setting region R24B, “mfp_usr” as the username in the authentication username input box Bx14, and “* * * * * * * * * * * *” as the authentication password in the authentication password input box Bx16. Subsequently, upon receiving an instruction to select the registration button B30 by the user, the controller 11 registers the authentication information input to the authentication username input box Bx14 and the authentication password input box Bx16.

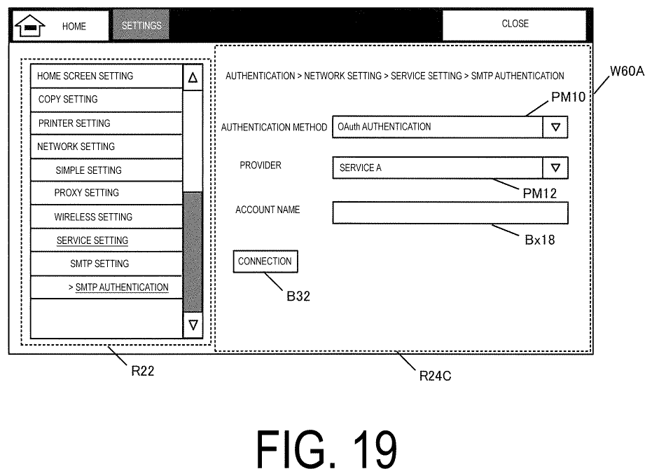

FIG. 19 is a diagram for explaining an example of a display configuration of an advanced setting region R24C displayed by the controller 11 when the user selects the OAuth authentication via the authentication method pull-down menu PM10. Upon receiving an instruction to select the OAuth authentication method as the authentication method, the controller 11 displays, in the advanced setting region R24C, a provider pull-down menu PM12 for receiving the selection of a provider (external service 50) as an authenticating entity, which is necessary for the OAuth authentication, and an account name input box Bx18 for receiving an input of an account name with respect to the provider.

At this time, the controller 11 changes the registration button B30 to a connection button B32, and displays the connection button B32 in the advanced setting region R24C.

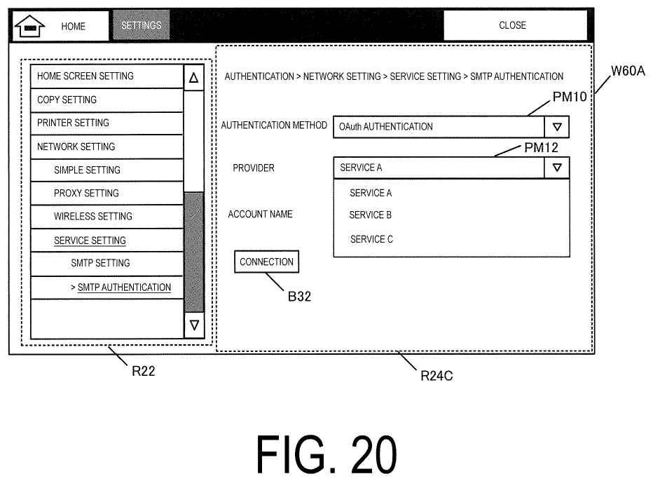

FIG. 20 is a diagram for explaining an operation example in a case where the downward arrow of the provider pull-down menu PM12 is selected by the user. Upon receiving the selection of the downward arrow by the user, the controller 11 displays a list of providers that can be selected by the user by expanding the display region of the provider pull-down menu PM12 in the downward direction. FIG. 20 illustrates an example in which service A, service B, and service C are displayed as the providers that can be selected by the user.

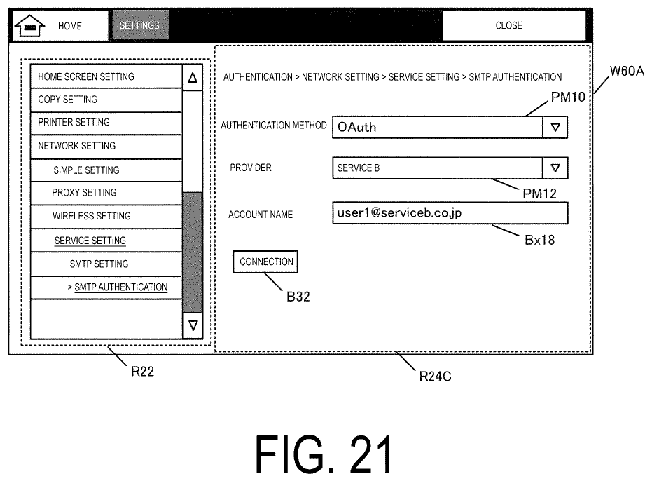

FIG. 21 illustrates an example in which the “service B” is selected by the user as the provider, which is the authenticating entity, in the advanced setting region R24C, and an account name “user1@serviceb.co.jp” is input to the account name input box Bx18. Subsequently, upon receiving an instruction to select the connection button B32 by the user, the controller 11 switches the control mode of the multifunction peripheral 10 from the device internal mode to the Internet connection mode in accordance with an input status of the account name input box Bx18. Then, the controller 11 starts cooperation (authentication processing) with the service B as the authenticating entity.

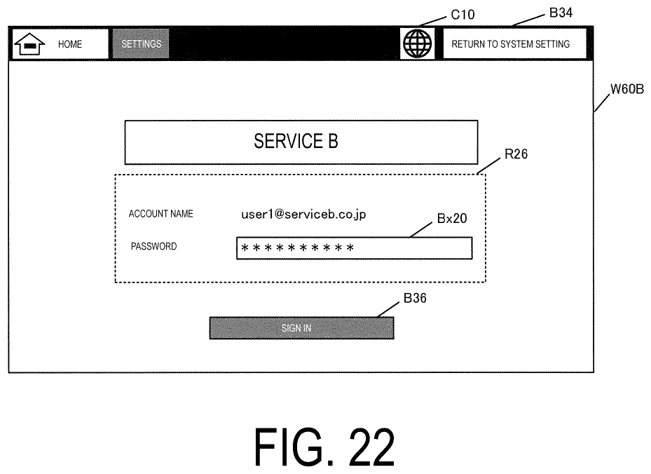

FIG. 22 is a diagram for explaining an example of a screen configuration of an authentication screen W60B, as a second setting screen, acquired from the service B serving as the authenticating entity (corresponding to the processing at step S30 and step S32 in FIG. 4). The authentication screen W60B includes a communicating state icon C10, a return to system setting button B34, an authentication information display region R26, and a sign-in button B36.

The communicating state icon C10 is an icon indicating that the multifunction peripheral 10 is communicating with the service B in the Internet connection mode. The communicating state icon C10 is displayed when the multifunction peripheral 10 is communicating with the service B, and is not displayed when the control mode of the multifunction peripheral 10 is the device internal mode, or when communication with the external service 50 such as the service B is not being performed.

The return to system setting button B34 is a button for receiving an instruction to end the display of the authentication screen W60B. When the return to system setting button B34 is selected by the user, the controller 11 ends the display of the authentication screen W60B and causes the display screen to transition to the system setting screen W60A.

The authentication information display region R26 includes a region for displaying the account name “user1@serviceb.co.jp”, and a sign-in password input box Bx20 with respect to the authenticating entity “service B”. The sign-in password input box Bx20 receives an input of a sign-in password for the service B.

The sign-in button B36 is a button for receiving an input of an instruction to sign in to the service B. Upon receiving an instruction to select the sign-in button B36 from the user, the service B performs the authentication processing based on the account name and the sign-in password.

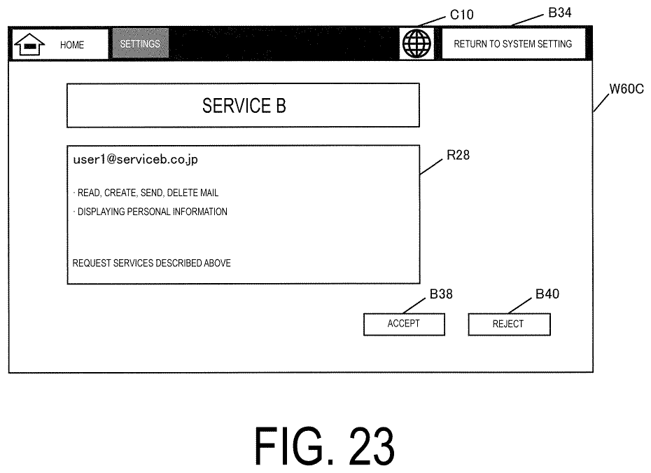

FIG. 23 is a diagram for explaining an example of a screen configuration of an authorization screen W60C acquired from the service B when the authentication processing of the authentication screen W60C illustrated in FIG. 22 is successful (corresponding to the processing at step S38 and step S40 in FIG. 4). The authorization screen W60C includes a requested authorization content display region R28, an accept button B38, and a reject button B40.

The requested authorization content display region R28 is a region for displaying, to the user (account name: user1@serviceb.co.jp), content of resources for which authorization is requested. FIG. 23 illustrates an example in which “read, create, send, delete mail” and “display personal information” are the requested authorization content.

The accept button B38 is a button for receiving a selection instruction to accept use of the resources displayed in the requested authorization content display region R28. The reject button B40 is a button for receiving a selection instruction to reject the use of the resources displayed in the requested authorization content display region R28. The service B can determine whether or not to provide the resources in accordance with the selection of the accept button B38 or the reject button B40.

Upon receiving the selection of the accept button B38, when the service B outputs an access token as an authorization response, the controller 11 switches the control mode of the multifunction peripheral 10 from the Internet connection mode to the device internal mode. Then, the controller 11 displays the system setting screen W60A, which will be described below with reference to the next diagram.

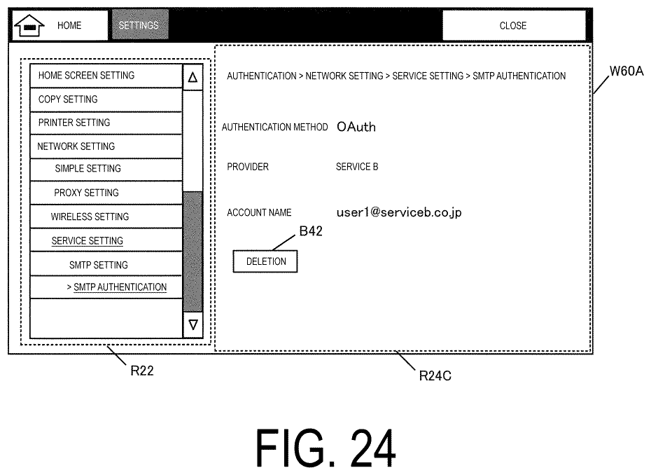

FIG. 24 is a diagram for explaining an example of a display configuration of the advanced setting region R24C displayed by the controller 11 after the access token has been acquired. In addition to the display of the authentication information with respect to the service B, the controller 11 displays a delete button B42 for receiving an input of an instruction to delete the acquired access token.

By selecting the delete button B42, the user can cancel the cooperation with the service B, that is, can end the use of “read, create, send, delete mail” and “display private information”.

As described above, according to the first embodiment, upon receiving the instruction to cooperate with the external service 50, the controller 11 switches the control mode of the device from the device internal mode related to the internal functions of the image forming device, to the Internet connection mode related to the cooperation with the external service 50. Then, the controller 11 causes the display screen to transition from the first setting screen related to the device internal mode (for example, the system setting screen W60A) to the second setting screen related to the Internet connection mode (for example, the authentication screen W60B). Since the transition of the display screen from the first setting screen to the second setting screen is performed seamlessly, it is possible to improve usability for the user related to the authentication processing. Further, according to the first embodiment, since the switching of the control mode can be controlled in accordance with the authentication method, the device can be operated flexibly with respect to the operation related to the authentication processing. Furthermore, when switching the control mode, for example, by requesting the input of the account name, it is possible to prevent the control mode from being erroneously switched to the Internet connection mode.

### 2. SECOND EMBODIMENT

In the first embodiment, as the control mode of the multifunction peripheral 10, a configuration has been described in which the device internal mode and the Internet connection mode are independently controlled. In a second embodiment, a configuration will be described in which the multifunction peripheral 10 is controlled in an integrated mode in which the device internal mode and the Internet connection mode are integrated.

Since the functional configuration of the multifunction peripheral according to the second embodiment can be similar to the functional configuration of the multifunction peripheral 10 according to the first embodiment, description thereof will be omitted here. The overall processing flow of the second embodiment is different from that of the first embodiment in that the internal server 112 (controller 11) does not switch the control mode from the device internal mode to the Internet connection mode at step S26 in FIG. 4, and the processing from step S26 onward is performed as screen transition processing of the integrated mode.

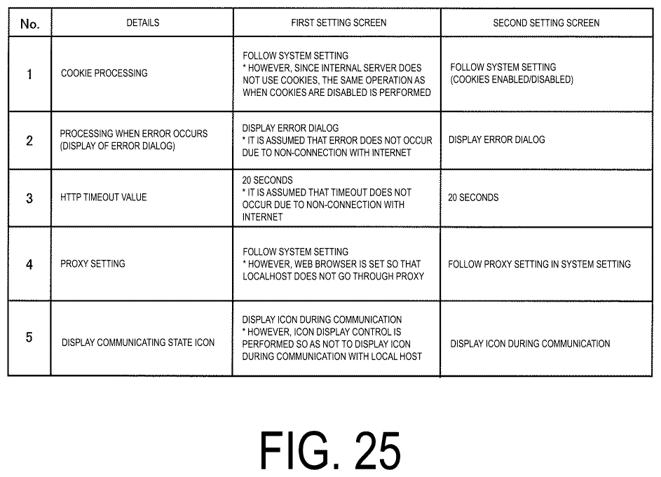

FIG. 25 is a table for explaining different points in the display control between the first setting screen and the second setting screen in the integrated mode. In FIG. 25, similarly to FIG. 3, as the different points, cookie processing, processing at a time when an error occurs (display of an error dialog), HTTP timeout value, proxy setting, and display of a communicating state icon will be described.

In display control of the first setting screen, communication with other external terminal devices including the external service 50 via the network NW1 (network NW2) is not performed. Therefore, main operation (setting) examples are cookie processing: “follow system setting (* however, since the internal server does not use cookies, the same operation as when cookies are disabled is performed)”, processing at a time when an error occurs (display of an error dialog): “display an error dialog (* assuming that no error occurs due to non-connection to the Internet)”, HTTP timeout value: “20 seconds (* assuming that no timeout occurs due to non-connection to the Internet)”, proxy setting: “follow system setting (* however, the Web browser is set so that local host does not go through proxy)”, and display of a communicating state icon: display the communicating state icon (* icon display control is performed so as not to display the communicating state icon during communication to local host”.

On the other hand, in display control of the second setting screen, communication with other external terminal devices including the external service 50 is performed via the network NW1 (network NW2). Therefore, main operation (setting) examples are cookie processing: “follow system setting (cookies enabled/disabled)”, processing at a time when an error occurs (display of an error dialog): “display an error dialog”, HTTP timeout value: “20 seconds”, proxy setting: “follow proxy setting in system setting”, and display of a communicating state icon: “icon is displayed during communication”.

As described above, according to the second embodiment, the multifunction peripheral 10 is controlled based on the integrated mode in which the device internal mode and the Internet connection mode are integrated. Thus, for example, the mode control program 231 according to the first embodiment and the processing of the controller 11 based on the reading of the mode control program 231 can be omitted. As a result, as compared with the first embodiment, it is possible to secure a larger storage capacity as a working area and speed up the processing by the controller 11.

### 3. THIRD EMBODIMENT

A third embodiment is an embodiment in which, at step S26 in FIG. 4 according to the first embodiment, when the internal server 112 (controller 11) switches the control mode from the device internal mode to the Internet connection mode, determination processing is performed to determine whether or not the user (login user), who has logged in to the multifunction peripheral 10, is an administrator user having administrator privileges.

Since a functional configuration of the multifunction peripheral according to the third embodiment can be similar to the functional configuration of the multifunction peripheral 10 according to the first embodiment, description thereof will be omitted here. Note that, in the case of the third embodiment, the controller 11 that has read the authentication (authorization) program 233 may perform administrator authentication with respect to the login user.

### 3.1 Processing Flow

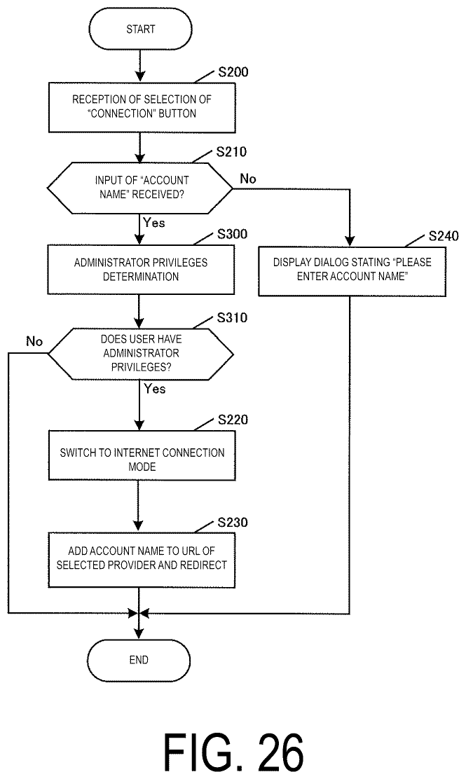

Overall processing according to the third embodiment can be performed in a substantially similar manner to that of the processing according to the first embodiment illustrated in FIG. 4. Note that detailed processing from step S22 to step S26 in FIG. 4 will be described with reference to a flowchart in which FIG. 6 is replaced with FIG. 26. Thus, steps at which the same processing as in FIG. 6 is performed are denoted by the same step numbers, and description thereof will be omitted.

At step S210 in FIG. 26, when it is determined that the input of the “account name” has been received, the controller 11 performs an administrator privileges determination to determine whether or not the login user who has logged in to the multifunction peripheral 10 has the administrator privileges (Yes at step S210 → step S300).

As a result of the administrator privileges determination, when it is determined that the login user has the administrator privileges, the controller 11 switches the control mode to the Internet connection mode (Yes at step S310 → step S220). On the other hand, when it is determined that the login user does not have the administrator privileges, the controller 11 ends the processing (No at step S310 → End).

### 3.2 Operation Examples

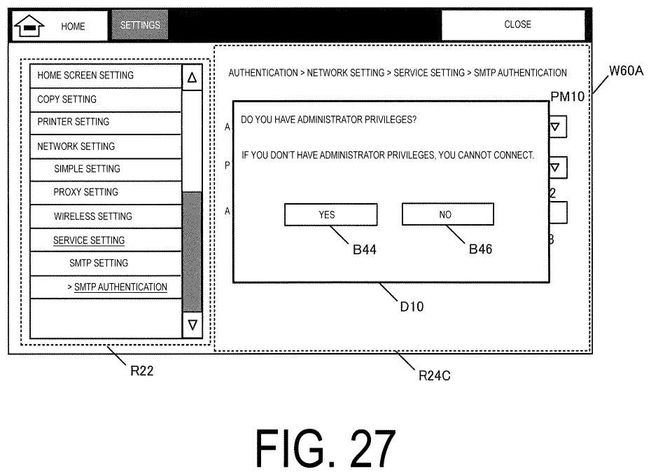

Next, operation examples according to the third embodiment will be described. FIG. 27 is a diagram for explaining, as an operation example related to the administrator privileges determination, an example of a display configuration example of a dialog D10 for submitting an enquiry to a login user as to whether or not the login user has administrator privileges.

The dialog D10 includes a message stating “Do you have administrator privileges?” and “If you do not have the administrator privileges, you cannot connect.” as display content, a Yes button B44, and a No button B46.

When the login user has the administrator privileges, the login user selects the Yes button B44 indicating that the user has the administrator privileges. Upon receiving the instruction to select the Yes button B44, the controller 11 performs the administrator authentication processing with respect to the login user. When it is determined that the login user has administrator privileges, the controller 11 switches the control mode to the Internet connection mode. Note that when it is determined that the login user does not have administrator privileges, the controller 11 displays a dialog D12, which will be described below with reference to the next diagram.

On the other hand, when the login user selects the No button B46 indicating that the user does not have administrator privileges, the controller 11 ends the processing.

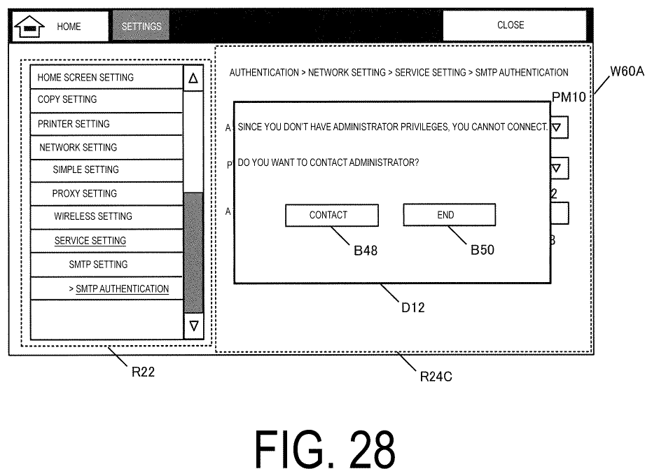

FIG. 28 is a diagram for explaining an example of a display configuration of the dialog D12 displayed by the controller 11 when the login user does not have administrator privileges as a result of performing administrator authentication with respect to the login user.

The dialog D12 includes a message stating “Since you do not have administrator privileges, you cannot connect.” and “Would you like to contact the administrator?” as display content, a contact button B48, and an end button B50.

Upon receiving the message stating “Would you like to contact the administrator?” of the dialog D12, when the login user selects the contact button B48, the controller 11 activates an application to contact an administrator user, such as an email application or an SMS application. When a plurality of administrator users are registered, contact addresses of the administrator users may be displayed in a selectable manner for the login user to decide which of the administrator users is to be contacted.

On the other hand, when the login user wishes to end the processing, the login user selects the end button B50. Upon receiving an instruction to select the end button B50, the controller 11 ends the processing.

As described above, according to the third embodiment, it is possible to prevent the authentication processing from being performed by a login user who does not have administrator privileges. In particular, the third embodiment is useful in an operating environment in which the management (operation) authority is strictly managed among the users of the multifunction peripheral 10.

The present disclosure is not limited to the embodiments described above and can be changed in various manners. In other words, embodiments obtained by combining technical mechanisms appropriately changed without departing from the gist of the present disclosure are also included in the technical scope of the present disclosure.

Although some parts of the above-described embodiments are described separately for convenience of explanation, it is a matter of course that combinations can be executed within a technically allowable range.

The programs running on each device in the embodiments are programs for controlling a CPU or the like (programs for causing a computer to function) to realize the aforementioned functions in the embodiments. The information handled by these devices is temporarily accumulated in a temporary storage device (for example, a RAM) at the time of processing, is then stored in a storage device such as a read only memory (ROM) or an HDD, and is read, corrected, and written by the CPU as needed.

The recording medium storing the programs may be any of a semiconductor medium (for example, a ROM, a nonvolatile memory card, or the like), an optical recording medium or a magneto-optical recording medium (for example, a digital versatile disc (DVD), a magneto optical disc (MO), a mini disc (MD), a compact disc (CD), a Blu-ray (trade name) disc (BD) or the like), a magnetic recording medium (for example, a magnetic tape, a flexible disk, or the like), and the like. Not only the aforementioned functions of the embodiments are realized by executing the loaded programs, but also the functions of the present disclosure may be realized by performing processing in cooperation with an operating system, another application program, or the like based on instructions of the programs.

In a case where the programs are distributed to the market, the programs can be stored and distributed in a portable recording medium, or can be transferred to a server computer connected via a network such as the Internet. In this case, it is a matter of course that the storage device of the server computer is also included in the present disclosure.

In addition, each functional block or each characteristic of the device used in the above-described embodiments can be implemented and executed by an electric circuit, for example, an integrated circuit or a plurality of the integrated circuits. An electric circuit designed to implement the function described herein may include a general-purpose processor, a digital signal processor (DSP), an application specific integrated circuit (ASIC), a field programmable gate array (FPGA) or other programmable logic devices, discrete gate or transistor logic, discrete hardware components, or a combination thereof. The general-purpose processor may be a microprocessor, or any known processor, controller, microcontroller, or state machine. The above-described electric circuit may be constituted by a digital circuit or an analog circuit. In addition, in a case where an integrated circuit technology that replaces the current integrated circuit becomes available due to advancement of the semiconductor technology, one or more aspects of the present disclosure can use a new integrated circuit based on the new integrated circuit technology.

### Reference Signs List

10 Multifunction peripheral
11 Controller
13 Display
15 Operation inputter
17 Image former
19 Image inputter
21 Communicator
23 Storage
231 Mode control program
232 Display control program
233 Authentication (authorization) program
234 Browser program
235 Server program
236 Application program
237 Authentication (authorization) information storage area
238 Screen information storage area
50 External service

1. An image forming device comprising:
a display displays a first setting screen and a second setting screen, the first setting screen receiving a setting related to an internal function of the image forming device and the second setting screen receiving a setting related to cooperation with an external service; and
one or more controllers,
wherein, in a case of receiving an instruction to cooperate with the external service via the first setting screen, the one or more controllers switch a control mode of the device from a first control mode related to the internal function of the image forming device to a second control mode related to the cooperation with the external service, and cause a display screen to transition from the first setting screen to the second setting screen.

2. The image forming device according to claim 1,
wherein the one or more controllers perform the transition of the display screen between the first setting screen and the second setting screen via a Web browser.

3. The image forming device according to claim 2,
wherein the one or more controllers receive, as the instruction to cooperate with the external service, a connection instruction based on a specific authentication method.

4. The image forming device according to claim 3,
wherein the authentication method received by the one or more controllers include an authentication method requiring a prior authorization.

5. The image forming device according to claim 4,
wherein, when the authentication method requiring the prior authorization is selected, the one or more controllers perform authentication processing with respect to the external service after switching to the second control mode related to the cooperation with the external service.

6. The image forming device according to claim 5,
wherein, when the authentication with respect to the external service is successful, the one or more controllers cause the display screen to transition from the second setting screen to the first setting screen.

7. The image forming device according to claim 6,
wherein the one or more controllers display, in the post-transition first setting screen, a delete button that receives an instruction to delete authentication information acquired from the external service.

8. The image forming device according to claim 1,
wherein the one or more controllers control the image forming device in an integrated mode in which the first control mode and the second control mode are integrated.

9. A control method for an image forming device, the image forming device including a display displaying a first setting screen and a second setting screen, the first setting screen receiving a setting related to an internal function of the image forming device and the second setting screen receiving a setting related to cooperation with an external service, and the control method comprising:
in a case of receiving an instruction to cooperate with the external service via the first setting screen,
switching a control mode of the device from a first control mode related to the internal function of the image forming device to a second control mode related to the cooperation with the external service; and
causing a display screen to transition from the first setting screen to the second setting screen.
